(19) United States
(12) Patent Application Publication
(10) Pub. No.: US 2015/0304409 A1
(43) Pub. Date: Oct. 22, 2015

(54) DETERMINING AT LEAST ONE COST FACTOR ASSOCIATED WITH USING THE CLOUD TO PROVIDE AN APPLICATION COMPONENT

(71) Applicant: Hewlett-Packard Development Comany, L.P., Houston, TX (US)

(72) Inventors: Rotem Steuer, Yehud (IL); Eyal Kenigsberg, Yehud (IL); Michael Gopshtein, Yehud (IL)

(73) Assignee: Hewelett-Packard Development Company, L.P., Houston, TX (US)

(21) Appl. No.: 14/439,518

(22) PCT Filed: Nov. 28, 2012
(86) PCT No.: PCT/US12/66808

§ 371 Date: Apr. 29, 2015

(51) Int. Cl. H04L 29/08; H04L 12/26

(52) U.S. Cl. CPC H04L 67/1008; H04L 67/101; H04L 43/04; H04L 43/0876

(57) ABSTRACT

A technique includes using a network sniffer to acquire at least one measurement of network activity associated with an application component, where the application component is a candidate to be migrated to a cloud. The technique further includes, based at least in part on the measurement(s), determining at least one cost factor associated with the application component being provided by the cloud.

### BACKGROUND

In certain circumstances, it may be economically efficient for an enterprise to rely on a cloud service to provide one or multiple computing services for the enterprise, In general, a cloud service is a service that allows end recipient computer systems (thin clients, portable computers, smartphones, desktop computers and so forth) to access a pool of hosted computing and/or storage resources (i.e., the cloud resources) and networks over a network (a publically accessible network, such as the Internet, for example). In this manner, the host, a cloud service provider, may, as examples, provide Software as a Service (SaaS) by hosting applications; Infrastructure as a Service (IaaS) by hosting equipment (servers, storage components, network components, etc.); or a Platform as a Service (PaaS) by hosting a computing platform (operating system, hardware, storage, etc.).

### BRIEF DESCRIPTION OF THE DRAWINGS

FIG. 1 is a schematic diagram of a network according to an example implementation.

FIG. 2 is a flow diagram depicting a technique to determine cloud service cost factors according to an example implementation.

FIG. 3 is a flow diagram depicting a technique to evaluate whether an application component should be migrated to the cloud according to an example implementation.

### DETAILED DESCRIPTION

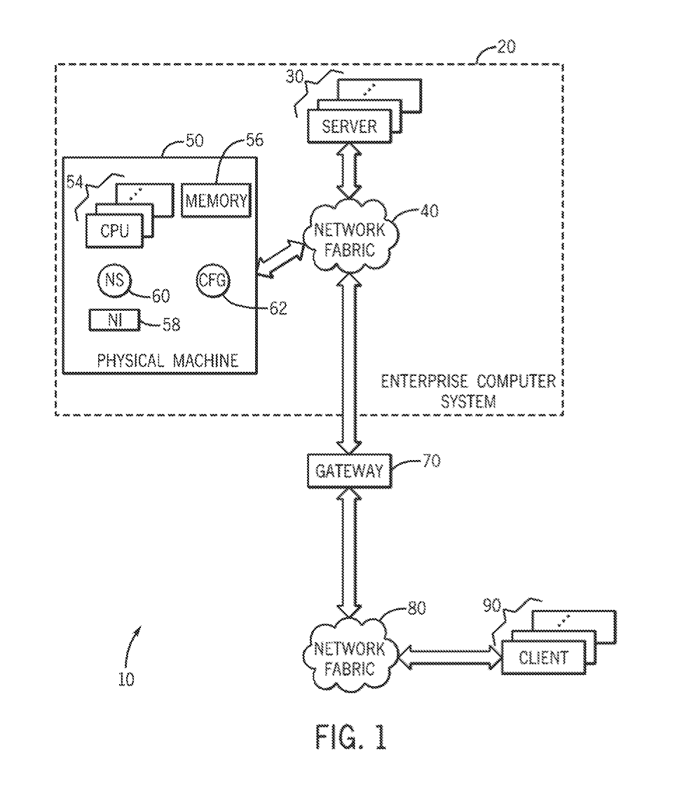

Referring to FIG. 1, systems and techniques are disclosed herein for purposes of evaluating whether a candidate application component (an entire application or a subcomponent of the entire application), which is currently not being hosted by the cloud should be migrated and hosted by the cloud. As an example, the candidate application component may be currently hosted by an enterprise system, such as an enterprise computer system 20 of an example network 10.

For purposes of aiding this evaluation, the enterprise computer system 20 includes a cost factor generator 62 and a network sniffer 60. In accordance with example implementations, the cost factor generator 62 and the network sniffer 60 may each be formed from a hardware-based processor (a central processing unit (CPU), for example), which executes machine executable instructions. Depending on the particular example implementation, the cost factor generator 62 and the network sniffer 60 may be executed on the same hardware-based processor or on different hardware-based processors. The cost factor generator 62 determines one or multiple cloud service cost factors for the candidate application component, which form the bases for the costs involved in using the cloud to alternatively host the candidate application component. In this manner, as further disclosed herein, the “cloud service cost factors” are parameters, such as storage requirements, network traffic assessments, number of users and so forth, which control the costs that will be incurred if the application component is hosted by the cloud and which may be entered into a particular cloud service provider's calculator for purposes of determining the cost of using the provider to host the application component.

As disclosed further herein, the cost factor generator 62 determines the cost factor(s) based on measurements that are acquired by the network sniffer 60. In this manner, the network sniffer 60 acquires measurements of the network activity associated with a given candidate application component, as the application component executes on its current, non-cloud-based system (i.e., the enterprise computer system 20, for this example). The operations and measurements of the network sniffer 60 do not disrupt or otherwise affect operation of the monitored candidate application component because the application component is executed by one or more other processing entities (such as one or more servers 30 of the enterprise computer system 20) that are independent from the execution entity(ies) that execute the network sniffer 60.

Thus, because the network sniffer 60 executes independently from the candidate application component and monitors the network activity of the application component without affecting operation of the application component, the cost factor generator 62 receives relatively accurate measurements of the application component's network activity. From these measurements, the cost factor generator 62 may determine cloud service cost factors for the candidate application component so that a relatively accurate assessment may be made of the potential costs and savings associated with having the cloud host the application component.

In accordance with the implementations disclosed herein, a “cloud,” may be, as examples, a public cloud (a cloud formed from an Internet-based network and provides hosted cloud services that are generally available to members of the public); a private cloud (a cloud formed from a private, limited access network (an enterprise network, for example), which provides hosted cloud services to a limited group of members); a virtual private cloud, such as a cloud formed from a public network providing hosted cloud services to a limited group of members; a hybrid cloud a cloud formed from a combination of two or more of the aforementioned clouds, for example; and so forth.

In general, the cloud may be viewed as a network-based economical model that may reduce the cost of providing a given application or application component. In this regard, the cloud may be a private and/or public or hybrid (public and private) network, whose hardware is shared to provide services for many entities for purposes of reducing such costs as equipment costs, real estate costs, electricity costs, license fees, and so forth. In general, the cloud excels in at least two aspects: elasticity, which is the ability of the cloud to have both periods of activity and inactivity; and scalability, which is the ability of the cloud to expand and contract on demand.

More specifically, the elasticity component of the cloud is the ability of the cloud to not be active all of the time, i.e., the ability of the cloud to not be active, for example, twenty-four hours a day/seven days a week. For example, a given, online storefront application executing on the cloud may have peak business hours, such as the normal store front hours of a flower shop, for example. Thus, a particular application may have normal, or “peak,” business hours, with the remaining hours being non-peak business hours, for example. In general, a cloud service pricing takes advantage of such elasticity due to charges not being incurred when the cloud service is available but not active. In other words, if no flower shop customers are accessing a corresponding cloud-based online store application for the flower shop during night time hours, then no charges are incurred during these hours.

The scalability aspect of the cloud pertains to a particular application having, in general, certain times when demand for the application is greater than other times. For the example of an online store application, the particular store may, for example, be subject to a holiday season; and during this holiday season, an increased number of users may access and purchase goods from the online store. This is to be contrasted to, for example, the non-holiday season, in which user sales and corresponding user activity are reduced. As another example, an online store may have a particular increased level of activity after a particular marketing event (a sales promotion, an advertisement, media coverage, and so forth).

Regardless of the reason for the increase and/or decrease, the services and/or hardware that are provided by the cloud relating to the application may be scalably expanded and/or retracted to respond to conform to the usage of he component. In this manner, the storage capacity, server capacity, and so forth, may be expanded for the hosted application during the peak season and correspondingly retracted during the off peak season.

As disclosed herein, the cost factor generator 62 and the network sniffer 60 are used in conjunction for purposes of evaluating whether a given candidate application component, which is currently not being hosted by the cloud may be hypothetically migrated to the cloud and thereafter hosted on the cloud in a cost efficient manner. Such a decision may involve considering one of several different factors. For example, such a decision may involve determining the cost of hosting the application component on the cloud, taking into account the related elasticity and scalability for the particular application component. Moreover, the decision may involve identifying which cloud service provider or providers out a number of possible cloud service providers are suitable due to their pricing to host the application component.

Additionally, a cloud service pricing model may be a factor in this decision. In this regard, the cloud service pricing model may be based on the level of internal network traffic (internal network traffic of server of application of the cloud, for example) as well as the level of external network traffic (network traffic between the cloud and users or between the cloud and outside services used by the cloud, for example).

The cloud pricing model may also be different, depending on the type of storage that is used. In this regard, the number of storage transactions, the sizes of these transactions and the overall nature of these transactions may affect the cost of the cloud service for the application component. In this manner, providing one thousand, one byte transactions may be associated with a cost that is significantly different than providing one, one thousand byte storage requests, even though the associated storage capacity is the same.

Thus, deciding whether to migrate a particular application component to the cloud may involve many different decisions, which are aided, in accordance with the examples disclosed herein, by the cost factors measurements acquired by the network sniffer 60; the resulting cost factors determined by the cost factor generator 62 as a result of these measurements and the resulting costs which may be determined by a cloud service provider's calculator based on these cost factors.

As depicted in an example in FIG. 1, for purposes of evaluating an application component, the enterprise computer system 20 includes a physical machine 50 that executes machine executable instructions stored in a memory 56 for purposes of providing the cost factor generator 62 and the network sniffer 60. As an example, the network sniffer 60 may be a remote user monitor (RUM), which is provided by Hewlett Packard, although other network sniffers may be used instead of RUM, in accordance with further implementations. Moreover, although described in the example herein as being executed on the physical machine 50, the network sniffer 60 may be distributed across multiple physical machines that perform distributed calculations/measurements for the network sniffer 60, in accordance with further implementations.

In general, the machine executable instructions are executed by one or multiple processing cores on one or multiple central processing unit(s) 54 of the physical machine 50. Thus, the physical machine 50 is an actual machine made up of actual hardware and software, in accordance with some implementations. In this regard, the physical machine 50 may have various other hardware components, such as a graphics adapter, a display, input devices, a network interface 58, and so forth, depending on the particular implementation.

In general, the physical machine 50 may be coupled to one or multiple processing entities, or servers 30, which execute the application component via network fabric 40. Thus, in accordance with example implementations, a processor-based (a CPU-based, for example) execution entity may execute machine executable instructions for purposes of forming the candidate application component, which is being evaluated for purposes of determining whether to migrate the component to the cloud. Moreover, for purposes of evaluating the application component, the network fabric 40 may be connected via a gateway 70 (an Internet gateway, for example) and network fabric 80 to one or more clients 90. In this manner, the clients 90 may be, for example, end user computers, onto which users may access the application component that is being evaluated by the cost factor generator 62 and network sniffer 60.

In accordance with some implementations, the candidate application component being evaluated by the network sniffer 60 may be part of an online application that is currently not hosted by the cloud. For example, a particular application may provide an online website having a uniform resource locator (URL) called “www.xyznews.com.” For this example, the candidate application component whose migration to the cloud is being considered may be a particular sports-related sub application having the URL “www.xyznews.com/sports,” with all of its application server components and relevant database tables. Thus, for these implementations, the network sniffer 60 may track, or monitor network traffic associated with the relevant www.xyznews.com/sports URL for purposes of identifying the network activity relevant to the candidate application component and acquiring measurements of this activity.

As a further example, in accordance with some implementations, the candidate application component may be identified by the portion of the application that processes a particular content. For example, using the www.xyznews.com/sports URL example above, the candidate application component may be more specific than the www.xyznews.com/sports sports URL or may not be associated with a URL or sub URL at all. Instead, the network sniffer 60 may identify the candidate application component using a specific content, such as, for example, all requests/replies that are associated with “English League Soccer,”

As yet another example, the network sniffer 60 may identify a particular application component using a particular transfer control protocol (TCP) or user datagram protocol (UDP) port number associated with that component. Thus, many variations are contemplated, which are within the scope of the appended claims.

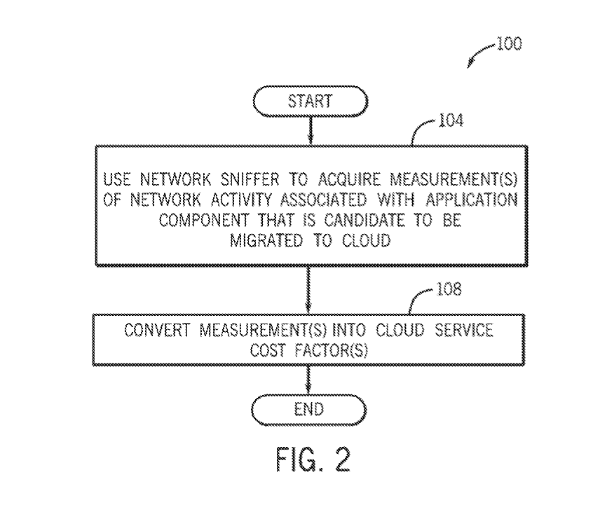

Thus, referring to FIG. 2 in conjunction with FIG. 1, its accordance with example implementations, a technique 100 includes using (block 1046 a network sniffer to acquire at least one measurement of network activity that is associated with a candidate application component whose potential migration to the cloud is being evaluated. Pursuant to block 108, the measurement(s) may be converted into at least one cloud service cost factor.

As a more specific example, the cloud service cost factors may include one or more of the following. The cost factors may specify the size (bandwidth, for example) and/or the number of network requests between internal servers, in accordance with some implementations. As another example, the cost factors may specify the number and/or size of requests between the server(s) 30 and users or external services accessed in connection with execution of the application component. The cost factors may also specify, for example, a number of storage requests taken to store data associated with the execution of the application component as well as the sizes of these requests. Moreover, the cost factors may specify the number of activity hours for the application component. The cost factors may specify a time-based profile, showing a model of peak times, thereby characterizing the elasticity and scalability factors for the application component.

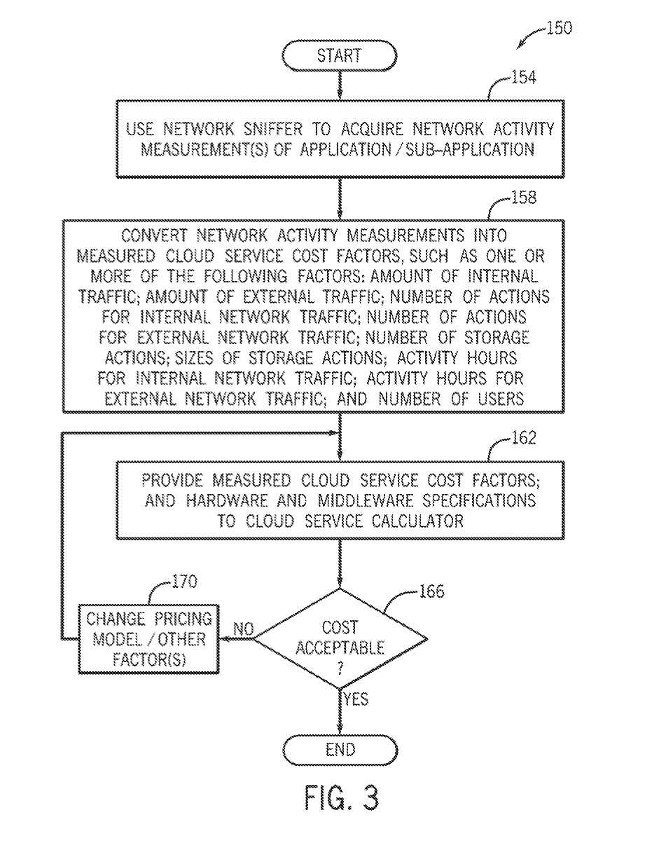

Thus, referring to FIG. 3 in conjunction with FIG. 1, in accordance with some implementations, a technique 150 includes using (block 154) a network sniffer to acquire network activity measurements of application/sub-application activity, i.e., the network activity measurements of a given candidate application component. The technique 150 includes converting (block 8) the network activity measurements into measured cloud service cost factors. These factors may include one or more of the following: the number of actions for internal network traffic, the number of actions for external network traffic, the amount (gigabytes (GB), for example) of the internal traffic, the amount of the external traffic, the number of storage actions, the sizes of storage actions, the activity hours for internal network traffic, the activity hours for external network traffic and the number of users.

Regardless of the specific cost factors that are considered, the technique 150 includes providing (block 162) the determined cost factors and also providing hardware and middleware specifications (as determined by a consultant, for example) to a cloud service cost calculator (an online cloud service cost calculation provided by the cloud service provider, for example). Based on the results of the cloud service cost calculator, a determination may then be made (decision block 166) whether the cost of having a particular cloud service provider host this application component is acceptable. If not, the pricing model and other factors may be changed, pursuant to block 170 such that control returns to block 162 in a potentially iterative process for purposes of determining the appropriate pricing model and/or whether it is economically efficient to migrate a particular application component to the cloud.

While a limited number of examples have been disclosed herein, those skilled in the art, having the benefit of this disclosure, will appreciate numerous modifications and variations therefrom. It is intended that the appended claims cover all such modifications and variations.

What is claimed is:

1. A method comprising:
using a network sniffer to acquire at least one measure lent of network activity associated with an application component, the application component being a candidate to be migrated to a cloud; and
based at least in part on the at least one measurement, determining at least one cost factor associated with the application component being provided by the cloud.

2. The method of claim 1, wherein the application is executed by at least one first processor-based entity, and using the network sniffer comprises acquiring the at least one measurement using a processor-based entity other than the first processor-based entity.

3. The method of claim 1, wherein using the network sniffer comprises using the network sniffer to acquire the at least one measurement independently from execution of the application component.

4. The method of claim 1, wherein determining the at least one cost factor comprises at least one of the following; determining a number of actions of the application component associated with external network traffic between the application component and a user or entity other than the application, determining a number of actions of the application component associated with internal network traffic for the application component, determining an amount of data communicated in the external network traffic, and determining the amount of data communicated in the internal network traffic.

5. The method of claim 1, wherein determining the at least one cost factor comprises determining a time profile of activity for the application component.

6. The method of claim 1, wherein determining the at least one cost factor comprises determining at least one of a number of storage requests and data sizes associated with the storage requests.

7. The method of claim 1, wherein determining the at least one cost factor comprises monitoring network activity associated with at least one of the following to: a uniform resource locator, a port and a content.

8. The method of claim 1, further comprising:
determining a cost for the application component to be provided by the cloud based at least in part on the at least one cost factor and a cloud service pricing model.

9. A system comprising:
a first processing entity to execute an application component, the application component being a candidate to be migrated to a cloud;
a network sniffer comprising a processor to operate independently of the first processing entity, the network sniffer to acquire at least one measurement of network activity associated with the application component; and
a cost factor generator to determine at least one cost factor associated with the application component being provided by the cloud based at least in part on the at least one measurement.

10. The system of claim 9, wherein the cost factor calculator is adapted to determine at least one of the following: a number of actions of the application component associated with external network traffic between the first processing entity and an external service or external users, a number of actions of the application component associated with internal network traffic to the first processing unit, determining an amount of data communicated in the external network traffic, and determining the amount of data communicated in the internal network traffic.

11. The system of claim 9, wherein the cost factor calculator is adapted to determine a time profile of activity for the application component.

12. The system of claim 9, wherein the cost factor calculator is adapted to determine at least one of a umber of storage requests and data sizes associated with the storage requests.

13. An article comprising a non-transitory storage medium to store instructions that when executed by a processor-based system cause the processor-based system to:
receive data representing at least one measurement acquired by a network sniffer indicative of network activity associated with an application component, the application component being a candidate to be migrated to a cloud; and
determine at least one cost factor associated with the application component being provided by the cloud based at least in part on the at least one measurement.

14. The article of claim 13, the storage medium storing instructions that when executed by the processor-based system cause the processor-based system to determine a time profile of activity for the application component.

15. The article of claim 13, the storage medium storing instructions that when executed by the processor-based system cause the processor-based system to determine at least one of a number of storage requests and data sizes associated with the storage requests.
